(19) United States
(12) Patent Application Publication
(10) Pub. No.: US 2021/0150628 A1
(43) Pub. Date: May 20, 2021

(54) INTERACTIVE VIRTUAL RETIREMENT PLANNING TOOL

(71) Applicant: Wells Fargo Bank, N.A., San Francisco, CA (US)

(72) Inventors: John A. Craft, Poolesville, MD (US); Sai Ganesh, Germantown, MD (US); John Phillip Marquiss, SR., Chambersburg, PA (US); Thomas A. Obreiter, Frederick, MD (US); John Lee Thompson, Sykesville, MD (US); Reynaldo B. Timonera, Frederick, MD (US); Kenneth Bryan von Hagel, Mount Airy, MD (US); Jingjiu Wang, Fairfax, VA (US); David W. Loomis, Clarksburg, MD (US); Irina Seabolt, Mount Airy, MD (US); Umamaheswari Veeraswami, Potomac, MD (US)

(21) Appl. No.: 15/454,607

(22) Filed: Mar. 9, 2017

(51) Int. Cl. G06Q 40/06; G06Q 50/00

(52) U.S. Cl. CPC G06Q 40/06; G06F 3/04847; G06Q 50/01

(57) ABSTRACT

A system, method, and computer media are provided for operating an interactive virtual retirement tool, comprising inputting user information into a memory of a computer system related to a plurality of quantifiable life goal elements, receiving a selection of one of the life goal elements, generating display information for the selected life goal element along with: a) image data associated with a value of the selected life goal element, and b) an adjustment control associated with the selected life goal element that allows modifying a value associated with the selected life goal element, receiving an adjustment from the adjustment control to modify the value to a new value, obtaining new image data associated with the new value using a processor of the computer system, and generating display information for the new image data.

### TECHNICAL FIELD

Described herein is a system and method that generally relate to a virtual retirement planning tool in which a user can adjust various parameters and scenarios and physically visualize on a computer display the impact of the adjustments on their retirement by integrating goal elements on the display.

### BACKGROUND

Users of financial systems and services often devote considerable resources to planning for their retirement. However, it is often difficult for the user to fully grasp the ramifications of different decisions that might be made, or the impact of different events or situations that the user may find themselves in. Users also fail to fully picture themselves living in the actual situations that their retirement planning efforts will leave them in. Often, the end result of retirement planning is a simple, “if I retire at age x, with this much money in my savings, and I expect to live until age y, then this is my cash flow”, which does not allow the user to fully understand their retirement plan.

### BRIEF DESCRIPTION OF THE DRAWINGS

In the drawings, which are not necessarily drawn to scale, like numerals may describe similar components in different views. Like numerals having different letter or numeric suffixes may represent different instances of similar components. The drawings illustrate generally, by way of example, but not by way of limitation, various embodiments discussed in the present document.

FIG. 1A is a block diagram of an example of an interactive virtual retirement planning tool system.

FIG. 1B is a block diagram of the life goals component breakdown.

FIG. 1C is a block diagram of a breakdown of the user display.

FIG. 2 is a flowchart of an example of a process for an interactive virtual retirement planning tool system.

FIG. 3 is a block diagram illustrating a machine that may be a computer on which various processes described herein may be performed.

FIG. 4 is a block diagram of a distributed computing system.

### DETAILED DESCRIPTION

Since, as discussed above, users of financial systems and services generally do not have a clear picture of their retirement beyond a simple cash stream over some number of years, it may be beneficial to provide users with a more complete picture of what their retirement may look like and allow the user to better understand the impact of various choices related to retirement. Many users could benefit from a more sophisticated system in which they could better visualize what their retirement would look like for them under different scenarios. Furthermore, by use of virtualization tools, users could have a more realistic image of what these different scenarios would actually look like.

Accordingly, a computer-implemented method is provided for operating an interactive virtual retirement tool, comprising inputting user information into a memory of a computer system related to a plurality of quantifiable life goal elements, receiving a selection of one of the life goal elements, generating display information for the selected life goal element along with: a) image data associated with a value of the selected life goal element, and b) an adjustment control associated with the selected life goal element that allows modifying a value associated with the selected life goal element, receiving an adjustment from the adjustment control to modify the value to a new value, obtaining new image data associated with the new value using a processor of the computer system, and generating display information for the new image data.

A system is also provided comprising a hardware processor, a network interface connected to the hardware processor that is connected to a network, a non-volatile memory connected to the hardware processor and the network interface comprising user asset information, user savings and investment information, a plurality of quantifiable life goal elements, a memory with instructions executable by the processor, the processor and memory with instructions comprising a life goals component comprising the life goal elements, an input component configured to input user information related to the life goal elements, a time-variant planning component configured to organize life goals and related life goal elements, an interactive adjustment component configured to generate display information comprising a selected life goal element, image data associated with a value of the selected life goal element, and an adjustment control associated with the selected life goal element that allows modification of a value associated with the selected life goal element, receive an adjustment from the adjustment control to modify the value to a new value, obtain new image data associated with the new value using a processor of the computer system, and generate display information for the new image data.

A non-transitory computer-readable storage medium is also provided, the computer-readable storage medium including instructions that when executed by a computer, cause the computer to perform operations of inputting user information into a memory of a computer system related to a plurality of quantifiable life goal elements, receiving a selection of one of the life goal elements, displaying the selected life goal element along with: a) image data associated with a value of the selected life goal element, and b) an adjustment control associated with the selected life goal element that allows modifying a value associated with the selected life goal element, receiving an adjustment from the adjustment control to modify the value to a new value, obtaining new image data associated with the new value using a processor of the computer system, and displaying the new image data.

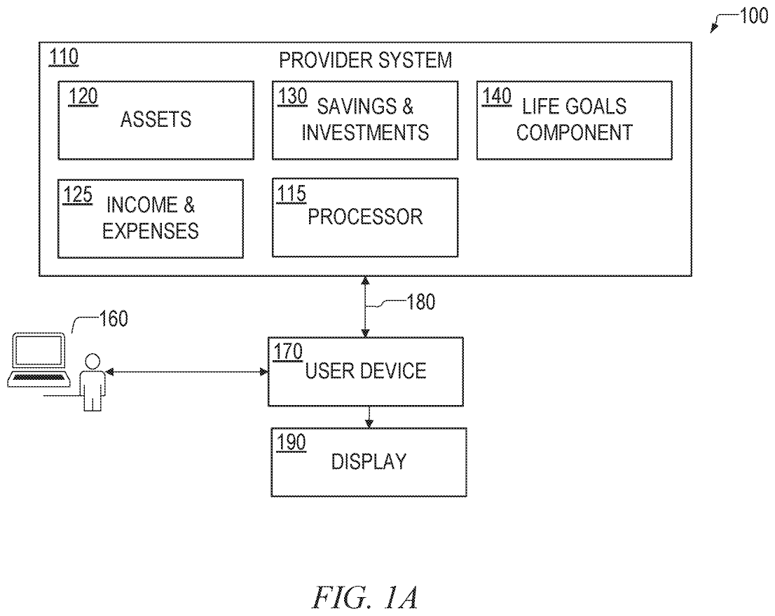

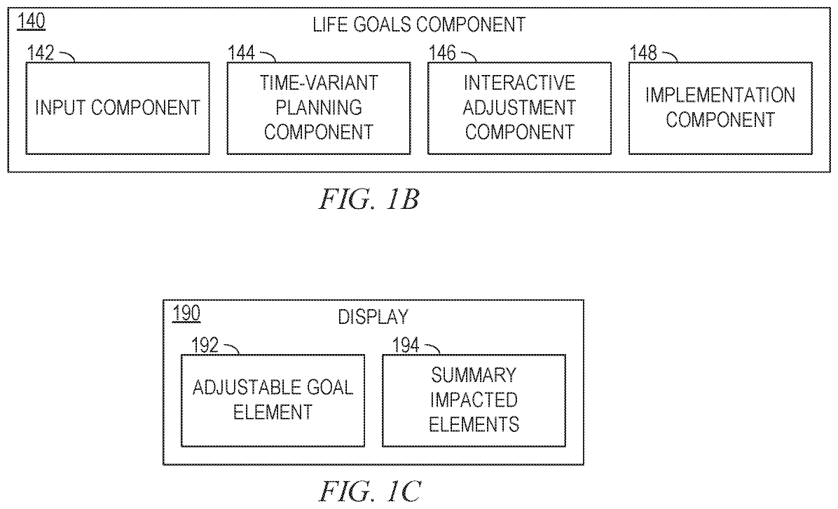

FIG. 1A is a block diagram of an example of an interactive virtual retirement planning tool system 100 involving a financial service provider system 110 and user 160 (who may be a user of a financial advisor associated with the provider system 110) with a user device 170 having a user interface component that is a display 190. The user device 170 may access the provider system 110 via a communication link/network interface 180. The provider system 110 can maintain traditional information about a user's 160 assets 120, such as their home, furnishings, car, property, their income and expenses 125, and their savings and investments 130, such as bank accounts, stocks, bonds, and other investment instruments. However, the provider system 110 herein also includes a user's life goals component 140 so that it may better help the user 160 prepare for retirement. The provider system 110 may include a processor 115 access information in the life goals component 140 and allow the user to visualize various retirement scenarios, based on information from or related to the user 160. Described in more detail below, the system 100 can show the user 160 their virtual retirement on the display 190 of the user device 170 so that the user 160 can clearly visualize what their retirement might look like under different scenarios, for example: if they keep on the same savings plan with the same income, where they might they be living, and what their hobbies might be. By visually seeing their retirement under different scenarios, the user might decide to make changes in their planning strategy for retirement.

FIG. 1B is a block diagram that breaks down the life goals component 140 into several components (discussed in more detail below): an input component 142, a time-variant planning component 144, an interactive adjustment component 146, and an implementation component 148.

The input component 142 may be used to acquire information related to the user's life goals. Initially, the system may start with a collection of customer inputs. The information may be obtained from a variety of sources, although some information sources may require permission of the user to access (this may be provided via opt-in provisions of a user agreement with the provider). Information may also be accessed via data already available in the provider system, such as information about the user's assets 120 and savings and investments 130. External sources of information may be used. For example, information may be used that is obtainable from a medical records database (health), social media (e.g., hobbies and interests), and publicly available databases or sources of data (costs associated with hobbies, interests, real estate, etc.). Gamification techniques may be utilized to provide inputs to the virtual retirement tool.

In one implementation, a user may be asked to provide information via a questionnaire, either via paper and pencil, or in the form of an on-line questionnaire. The system could provide a questionnaire that may include social or psychological-type questions, such as strength or interest finders, and/or help determine various factors, such as tolerance for risk. The questionnaire could present simple questions to the user having simple answers. For example, it could ask the user a series of questions, such as, “do you prefer indoor or outdoor activities”, and “would you rather be golfing or sailing”. More complex questions or selection lists may be presented to the user as well.

Answers to the questionnaire may be used to outline the user's goals. To provide some form or structure, predicted or determined goals or goal elements may be based on normative data or categories for similarly situated individuals. For example, the system may predict or determine that a user living near the ocean may have goals related to boating or fishing, whereas a 90-year old person is unlikely to have goals related to skydiving. The goals may focus around broad themes such as a living situation (owning, renting, reverse mortgage, living location, size of home, etc.), hobbies and interests (travel, fishing, theater, boating, stamp collecting, etc.), family (estate planning), and other themes.

Once the broad themes for goals are outlined, the time-variant planning component 144 may be utilized to identify supporting monetarily quantifiable elements (“goal elements”) that may help the user achieve their goals. Initial targets may be identified by the user. For example, the user may indicate, “I would like to own a 2000 square foot home located in the suburbs of Boston”, as a goal element supporting their living situation. Another might be, “I would like to own a 19-foot bowrider”, as a goal element supporting their boating hobby.

The goal elements may be time-variant, meaning that the 19-foot bowrider supporting the boating hobby for the user at age 65 might be sold off, with a canoe supporting the boating hobby for the user at age 80. Normative and health predictions obtained from external sources could be used to provide information about goals of similarly situated individuals and how such individuals are meeting their goals under similar circumstances. Thus, the system may be able to predict various goals and goal elements that might be relevant to the user.

The income and expense streams may be time variant as well. To this end, the system can present a complete timeline display/picture of a user's overall financial situation, from a current work situation through retirement and up until an anticipated time of death (e.g., based on actuarial information that could be provided to the system). The overall financial situation could include the user's net worth, income and expense streams, asset value breakdown, and goal element breakdown. The timeline may show, at any point in time for the user, an overall financial situation of the user. The overall financial situation may include any or all of net worth, asset breakdown, income and expense streams, and goal or goal element breakdown.

Advantageously, the user's situation can be easily updated over time to accommodate unforeseen changes in circumstances. For example, an unforeseen windfall inheritance or lottery winning could positively impact retirement, whereas a layoff or illness could negatively impact retirement. Or, the user's interests could change over time—e.g., the user acquires a new hobby, such as gardening, that they want to pursue. Notifications could be provided to the user when events occur that might have an impact on some aspect of their retirement. For example, if the stock market drops significantly, the user could be sent an email alerting her of this fact and illustrating the impact on a particular retirement scenario that the user has indicated. The system could notify the user based on any change in a life goal or life goal element and possibly provide alternatives for the user, such as moving investments into less volatile instruments.

The interactive adjustment component 146 may then be used allow the user to view what their retirement (or current financial situation) looks like from any point in time, using the goal elements and the goals they support as a focal point. This view may include, for example, demographics, goals, a lifestyle the user wants to live, location, and health picture, among other things, taking age into consideration.

The system may present an adjustable virtual retirement experience for the user that is described in the following use case, which provides an example of how the system 100 might be used.

In the use case, for the input component 142 described above, a questionnaire is provided to the user. This may be a paper and pencil questionnaire and/or a computer-based questionnaire. The computer-based questionnaire may be more flexible because it may dynamically respond to user indications or choices. Such a computer-based questionnaire could be run as a dedicated program on the user device 170, or it could be accessed on a server computer (via the processor 115) of the provider system 110, such as through a web browser. A financial advisor could also administer all or parts of the questionnaire or help guide the user in answering relevant questions.

Using the computer-based questionnaire as an example, the questions may focus on broad themes, such as living situation, hobbies and interests, and family. For the living situation, the questionnaire might ask about desired ownership information (house, condo, apartment, own, rental), size and attributes of living situation (square feet, number of bedrooms, lot size), and location. For hobbies and interests, the questionnaire might present a list of typical hobbies and interests that the user could select from. The user might select boating, theater, and stamp collecting as hobbies and interests they would like to pursue into retirement.

In one implementation, information relevant to the user may be obtained from social media or other sources beside direct input from the user. For example, the user's Facebook account could be accessed (with appropriate permission) via the Internet to determine likely hobbies and interests that the user has and make predictive suggestions to the user based on user-indicated likes, things the user is following, user posts, and the like. For example, if the user is following several golf courses and has a number of posts mentioning golf, the system could determine that it is very likely that golf is one of the user's hobbies. Geographic information may be utilized as well. For example, a user who lives or expresses an interest in living in Boston may have more of an interest in ocean-related activities, such as boating or fishing.

Once the system has determined particular hobbies and interests, the questionnaire could focus in on these by asking a series of questions supporting each of them. For example, with regard to the boating hobby, the questionnaire could ask whether to focus on fishing, sailing, powerboating, and so on. The questionnaire may ask a series of more and more refined questions relating to the hobby and interest to allow the creation of specific goal elements. In the use case, the specific goal element may be a 19-foot bowrider. This goal element could either be directly entered by the user who knows specifically what goal element supports their interest, or it could be presented by the system as a selectable option for the user, possibly taking into account information known about the current and future financial situation of the user or some value specified by the user. If the user does not know specifically what goal elements support their goal, they could specify some target amount of money that should be considered for the overall goal or individual goal elements. The system 110 could then consider typical purchases that might be made by a similarly situation person with the target dollar amount and present these to the user.

With regard to the living situation, the final goal element may be a 2000 square foot, three-bedroom, two-car garage single-family home located within 25 miles of downtown Boston. The goal elements can be more flexibly considered if they are monetarily quantifiable, since this can permit similar elements to be presented to the user (e.g., presenting an equivalently-priced home located within 10 miles of downtown Miami, or going with a five-year-old 25-foot bowrider versus a 19-foot new bowrider).

As noted above, the system may take into account the user's current and future financial situation into account in providing various options by looking to the user's assets 120, savings and investment 130, as well as anticipated income streams and expenses. For example, it may present the 19-foot bowrider for a user in a particular financial situation, and not present a 40-foot yacht to someone whose financial picture indicates that this would not be affordable, or at least the system could display some sort of red flag if the user indicates this as a goal element (in other words, the system can flag elements when unachievable goal elements are specified or changes to a goal element require substantial modification to existing ones). The system may access a wide variety of resources in determining the cost of various goal elements, such as real estate listings for property and merchant websites for others. As part of a visual experience provided to the user, it can show pads, timelines, and steps needed for each of the goal elements and goals they support.

One advantageous feature of the system may be the interactive adjustment component 146, which may allow the user to interact with the provider system 110 and their particular goals in the life goals component 140 in a visual manner. The interactive adjustment component 146 may allow a user to see the impact of changing parameters associated with a particular goal or goal element, and thus allow the user to better visualize and determine alternatives related to their goals and goal elements.

Referring to FIG. 1C, which is a block diagram of a breakdown of the user display 190, and using the use case above, the user display (e.g., laptop screen) 190 of a user device 170 (e.g., laptop) might show the hobby and interest portion of their virtual retirement, based on a user selection. When the user selects a sailing goal element, a boat sub-element might appear in an adjustable goal element 192 portion of the display. This may provide the user with a picture and a price (or amortization) of the 19-foot bowrider that was selected as a goal element. A slider user element (not shown) as an adjustable element user control could be provided that allows the user to adjust the price portion of the boat. For example, if the 19-foot bowrider has an indicated price of $30,000, the user could adjust the slider to $100,000 to observe the overall impact of dedicating more resources to this portion of the user's hobbies and interests. The system could then access external databases or systems to locate different items (e.g., the system could access one or more boat seller web sites information of a larger boat) at the new price point, and display these to the user.

However, adjusting the boat slider from $30,000 to $100,000 will impact other aspects or elements of the user's goals. For example, it might mean reducing dollars allocated to other hobbies and interests, having a less expensive living situation, or requiring a higher pre-retirement rate of savings. To allow the user to quickly see the impact the change in the adjustable goal element has, a summary of impacted life goal elements 194 could be presented on the display 190 along with adjustable goal element 192 that, in the present example, includes the slider element and boat options so that as the user adjusts the boat price, the impact on the other aspects can be viewed as well. Such an adjustment on the summary of other aspects could be in the form of, for example, a “calculate it now” button, in which case updates may be performed at the press of the button, or the updates could be done in real-time as the slider moves, depending on the processing power available.

Given that a user will typically have a number of goal elements and aspects of their financial situation, it may be beneficial to allow the user to lock or otherwise limit various elements of the summary of impacted elements 194 on the display as parameters are adjusted by way, e.g., of a checkbox or radio button for lock, and field entries for limitations (ranges, conditional statements, etc.). For example, the user could indicate that they do not want their living situation to change (e.g., lock the 2000 square foot home located in the Boston suburbs), and lock down other goal elements in the summary of impacted elements 194, in which case the system might display as a part of the summary of impacted elements 194 that the user needs to have a larger amount of money saved at retirement if they want to get the 25-foot bowrider. Using a multi-level impact feature display, this requirement for greater savings may initially indicate a need for an additional $70K at retirement, and may, in turn, indicate to the user that they need to increase their retirement savings from 6% to 12%, or to postpone retirement from age 62 to 65 in order to achieve that $70K additional money needed.

As noted above, instead of an outright lock (e.g., “do not change the $400K living situation value”) placed on the impacted elements 194, limits could be placed (e.g., “allow my living situation value to vary between $250K and $500K”). This could allow the system greater flexibility in adjusting various other parameters in response to a user's change via the adjustable goal element 192. Furthermore, a user could specify a level of importance to all of the factors. For example, the user could assign a value of 10 (very important) for the housing goal element (i.e., “do not reduce the $400K allocated to living situation unless absolutely critical”), and a value of 2 (not so important) for the hobby goal element (i.e., “the boat is optional and should be the first thing eliminated, if necessary”).

Importance levels may also be provided for sub-factors as well. For example, within the living situation goal, a value of 8 (quite important) could be assigned to the 2000 square foot goal element, a value of 10 (very important) could be assigned to the living in the Boston area goal element, but a value of 5 (moderately important) could be assigned to the “within 25-miles of downtown” goal element. Thus, in response for the additional $70K needed for the larger boat indicated via the adjustable goal element 192, the system may be much more likely to recommend moving out to 40 miles from downtown Boston, as opposed to reducing the house square footage to 1350 square feet.

Using this system and the features described above, a visual retirement planning process may use a variety of different types of devices to collect information and to craft, monitor, and update a user's retirement plan on a regular basis and maybe make it a visual experience. User images could be uploaded into the system so that even the user's image could be superimposed into or projected onto various retirement scenarios or items (user in a house, user in a boat, user driving an automobile, user on a golf course) and shown to the user as image data. Or the image data could simply be images of items associated with the goal elements themselves, such as images of boat models, specific homes at particular locations, automobiles, etc.

The time-variant planning component could also take into account factors such as inflation (general and in specific sectors, like boat prices, education for a beneficiary, etc.), expected interest rates, and long-term market performance. Such information (actual and estimated) may be obtained from external sources and utilize various algorithms to make future projections.

The implementation component 148 may tie into the user's actual retirement planning systems and allow changes considered using the tool to actually be implemented. For example, in the above use case, the user may indicate that they are interested in the 25-foot bowrider, as opposed to the 19-foot bowrider. After locking down various other aspects, the system may indicate a solution as increasing their deferred savings from 6% to 12%, or recommending moving $100K from money market accounts into a medium-yield mutual fund. The system could then implement the savings changes or funds transfer after prompting the user (with, e.g., a “do-it-for-me” button on the display) to confirm that they would like to implement the indicated changes.

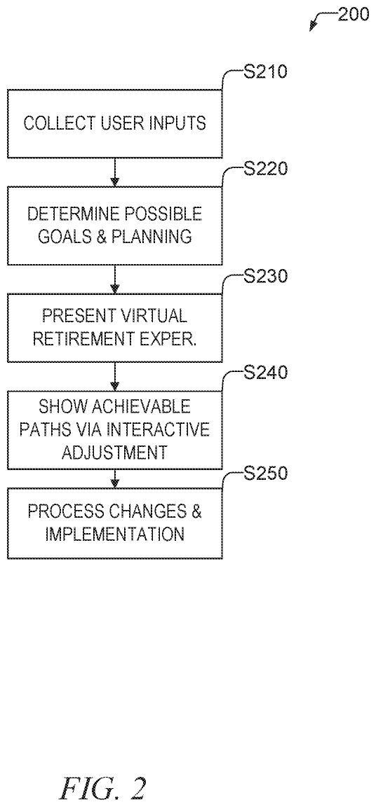

FIG. 2 is a flowchart 200 for a process that may be used to implement the system 100. First, in operation S210, user inputs may be collected that can go into creating the retirement plan, as described above with respect to the input component 142. These inputs can be used to establish a retirement point, to provide demographic information (age, marital status, background information), goals (lifestyle, assets, money, personal goals), financial information, locations (e.g., where will they want to retire), health, family (spouse, kids), risk tolerance, audio-visual data (e.g., pictures of kids, spouse, hobbies, property).

Next, in operation S220, based on the input data, possible goals and respective goal elements may be created, either directly by the user or predicted based on a variety of factors, as described above with respect to the time-variant planning component 144. Other planning activities may take place in this operation as well.

Next, in operation S230, a virtual working and retirement experience may be presented to the user that incorporates the goal elements described above. The presentation may take place on the user's display 190 and could incorporate images of the user interacting with specifics of the goal elements, such as sailing on the 19′ bowrider or standing in the lawn in front of a 2000 square foot Boston suburb home.

In operation S240, various achievable paths can be presented to the user, including those obtained by the user changing and interacting with the adjustable goal element 192. In operation S250, when the user achieves a desired plan, actual changes that need to be implemented, such as an increase in the savings amount, can actually be implemented by the user via the implementation component 148. In this way, the user may have an effective virtual retirement planning tool that allows them to clearly visualize a number of areas of their retirement, based on their own goals for retirement, and allow the user to see the impact of various changes. This example of a virtual retirement system may let users interact and create and track their goals, adjust various factors, such as contributions, related to their goals in a more visual manner. A financial planner may utilize a Skype meeting to show the user their virtual retirement, or the user can interact with the tool themselves, so that the user can see what their retirement might look like under various scenarios.

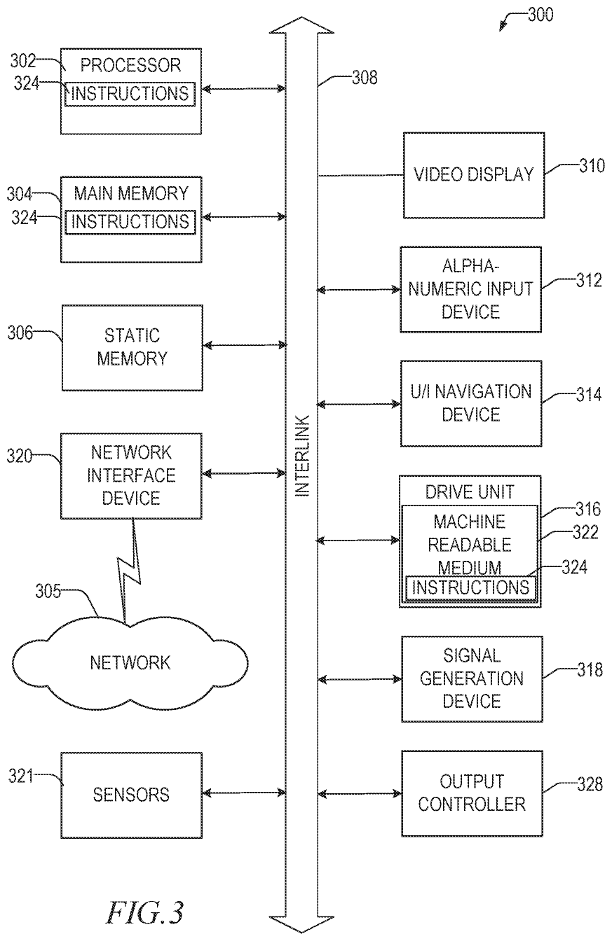

To describe some configurations in greater detail, reference is made to examples of hardware structures and interconnections usable in the designs of the present disclosure. FIG. 3 is a block diagram illustrating a machine that may be a computer on which various processes described herein may be performed. The machine (e.g., computer system) 300 may include a hardware processor 302 (e.g., a central processing unit (CPU), a graphics processing unit (GPU), a hardware processor core, or any combination thereof), a main memory 304 and a static memory 306, some or all of which may communicate with each other via an interlink (e.g., bus) 308. The machine 300 may further include a display unit 310, an alphanumeric input device 312 (e.g., a keyboard), and a user interface (UI) navigation device 314 (e.g., a mouse). In an example described herein, the display unit 310, input device 312 and UI navigation device 314 may be a touch screen display. The machine 300 may additionally include a storage device (e.g., drive unit) 316, a signal generation device 318 (e.g., a speaker), a network interface device 320 (the network interface may correspond to the communication link 180), and one or more sensors 321, such as a global positioning system (GPS) sensor, compass, accelerometer, or other sensor. The machine 300 may include an output controller 328, such as a serial (e.g., universal serial bus (USB)), parallel, or other wired or wireless (e.g., infrared (IR), near field communication (NFC), etc.) controller connection to communicate or control one or more peripheral devices (e.g., a printer, card reader, etc.).

The storage device 316 may include a machine readable medium 322 on which is stored one or more sets of data structures or instructions 324 (e.g., software) embodying or utilized by any one or more of the techniques or functions described herein. The instructions 324 may also reside, completely or at least partially, within the main memory 304, within static memory 306, or within the hardware processor 302 during execution thereof by the machine 300. In an example, one or any combination of the hardware processor 302, the main memory 304, the static memory 306, or the storage device 316 may constitute machine readable media.

While the machine readable medium 322 is illustrated as a single medium, the term “machine readable medium” may include a single medium or multiple media (e.g., a centralized or distributed database, and/or associated caches and servers) configured to store the one or more instructions 324.

The term “machine readable medium” may include any medium that is capable of storing, encoding, or carrying instructions for execution by the machine 300 and that cause the machine 300 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 324 may further be transmitted or received over the communications network 305 using a transmission medium via the network interface device 320. The term “transmission medium” is defined herein to include any medium that is capable of storing, encoding, or carrying instructions for execution by the machine, and includes digital or analog communications signals or other medium to facilitate communication of such software.

The machine 300 may communicate with one or more other machines 300 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, virtual private networks (VPN), or any other way of transferring data between machines 300. In an example, the network interface device 320 may include one or more physical jacks (e.g., Ethernet, coaxial, or phone jacks) or one or more antennas to connect to the communications network 326.

In an example, the network interface device 320 may include a plurality of antennas to wirelessly communicate using at least one of single-input multiple-output (SIMO), multiple-input multiple-output (MIMO), or multiple-input single-output (MISO) techniques. In some examples, the network interface device 320 may wirelessly communicate using Multiple User MIMO techniques.

A wide variety of computing devices may constitute a machine 300, as described herein. The following list includes a variety of devices that may fit the definition of a machine 300: a personal data assistant (PDA), a cellular telephone, including a smartphone, a tablet computing device, a laptop computer, a desktop computer, a workstation, a server computer, a mainframe computer, and the like. The provider system 110 may include one or more machines 300, as described above, and the user device 170 may be a machine 300, as described as well.

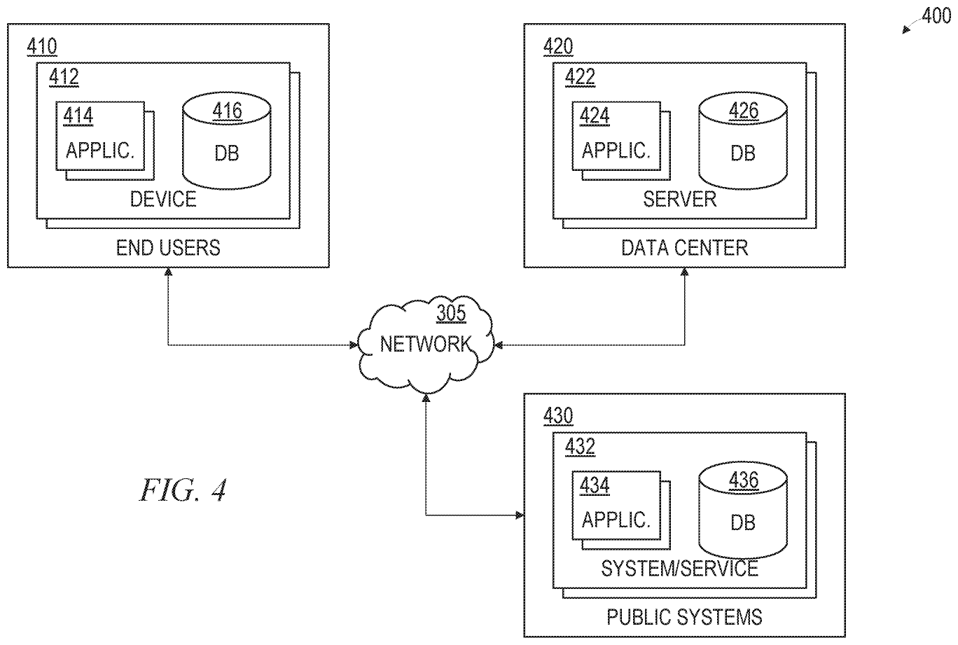

FIG. 4 is a block diagram of a distributed system 400 that may include a user-server architecture or cloud computing system. Distributed system 400 may have one or more end users 410. An end user 410 may have various computing devices 412, which may be machines 300 as described above. The end-user computing devices 412 may comprise applications 414 that are either designed to execute in a stand-alone manner, or interact with other applications 414 located on the device 412 or accessible via the network 305. These devices 412 may also comprise a data store 416 that holds data locally, the data being potentially accessible by the local applications 414 or by remote applications.

The system 400 may also include one or more data centers 420. A data center 420 may be a server 422 or the like associated with a business entity that an end user 410 may interact with. The business entity may be a computer service provider, as may be the case for a cloud services provider, or it may be a consumer product or service provider, such as a retailer. The data center 420 may comprise one or more applications 424 and databases 426 that are designed to interface with the applications 414 and databases 416 of end-user devices 412. Data centers 420 may represent facilities in different geographic locations where the servers 422 may be located. Each of the servers 422 may be in the form of a machine(s) 300.

The system 400 may also include publicly available systems 430 that comprise various systems or services 432, including applications 434 and their respective databases 436. Such applications 434 may include news and other information feeds, search engines, social media applications, and the like. The systems or services 432 may be provided as comprising a machine(s) 300.

The end-user devices 412, data center servers 422, and public systems or services 432 may be configured to connect with each other via the network 305, and access to the network by machines may be made via a common connection point or different connection points, e.g. a wireless connection point and a wired connection. Any combination of common or different connections points may be present, and any combination of wired and wireless connection points may be present as well. The network 305, end users 410, data centers 420, and public systems 430 may include network hardware such as routers, switches, load balancers and/or other network devices.

Other implementations of the system 400 are also possible. For example, devices other than the user devices 412 and servers 422 shown may be included in the system 400. In an implementation, one or more additional servers may operate as a cloud infrastructure control, from which servers and/or users of the cloud infrastructure are monitored, controlled and/or configured. For example, some or all of the techniques described herein may operate on these cloud infrastructure control servers. Alternatively, or in addition, some or all of the techniques described herein may operate on the servers 422. The end users 410 in FIG. 4 may be, for example, the users 160 of FIG. 1A, and the data center 420 of FIG. 4 may be, for example, the provider system 110 of FIG. 1A. External systems, as described above, may be implemented, by way of example, by the public systems 430.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products.

Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like. The code may also be intangibly stored on one or more non-transitory and non-volatile computer readable media, such as those described above. In these cases, instructions resident on the media are read and executed by a processor to perform various functions.

The above description is intended to be illustrative, and not restrictive. For example, the above-described examples (or one or more aspects/configurations thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it should not be used to interpret or limit the scope or meaning of the claims.

Also, in the above Detailed Description, various features may be grouped together to streamline the disclosure. However, the claims cannot set forth every feature disclosed herein, as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the claims, along with the full scope of equivalents to which such claims are entitled.

1. A computer-implemented method for operating an interactive virtual retirement tool, comprising:
storing, into a memory of a computer system, user information from social media accounts associated with a user;
identifying a set of interests based on the user information;
determining a set of suggested life goal elements based on the set of interests;
receiving a life goal location from the user, wherein the life goal location indicates a geographic location for achieving the set of suggested life goal elements;
determining a set of compatible life goal elements from the set of suggested life goal elements based on a compatibility determination between characteristics of the life goal location and each respective suggested life goal element of the set of suggested life goal elements for achieving the respective suggested life goal element;
generating a user interface including the set of compatible life goal elements;
receiving a selection of one of the compatible life goal elements;
generating display information for the selected life goal element along with:
a) image data associated with a value of the selected life goal element, and b) an adjustment control associated with the selected life goal element that allows modifying the value of the selected life goal element;
receiving an adjustment from the adjustment control to modify the value to a new value;
obtaining new image data associated with the new value using a processor of the computer system; and
generating display information for the new image data.

2. The method of claim 1, further comprising:
generating display information for impacted life goal elements along with the selected life goal element;
modifying a value of one or more of the impacted life goal elements based on the new value; and
generating display information for the modified value for the impacted life goal elements.

3. The method of claim 2, further comprising:
receiving limitations related to changes allowed for one or more impacted life goal elements, wherein the modifying of the value of the one or more of the impacted life goal elements is within the received limitations.

4. The method of claim 3, wherein the limitations are a lock preventing a change of a value or a range of values that bound the one or more impacted life goal elements.

5. The method of claim 1, wherein the value and the new value are monetary values.

6. The method of claim 1, wherein storing the user information further comprises receiving the user information via a network interface of the computer system based on a web-browser-based questionnaire.

7. The method of claim 1, wherein storing the user information further comprises receiving the user information via a network interface of the computer system based on social media connections.

8. The method of claim 1, wherein the suggested life goal elements are time-variant life goal elements.

9. The method of claim 1, further comprising inputting the image data via a network interface and from a publicly available source that is external to the computer system.

10. The method of claim 1, further comprising:
predicting, using the processor, a predicted goal element based on the user information; and
adding the predicted goal element to the set of suggested life goal elements.

11. The method of claim 1, further comprising receiving an indication to implement a transaction consistent with the received adjustment.

12. The method of claim 1, further comprising displaying a timeline for an overall financial situation of the user.

13. The method of claim 12, wherein the overall financial situation of the user includes net worth, asset breakdown, income and expense streams, and goal element breakdown.

14. A system comprising:
a hardware processor;
a network interface connected to the hardware processor that is connected to a network;
a non-volatile memory connected to the hardware processor and the network interface, including instructions that, when executed by the hardware processor, cause the hardware processor to:
store user information from social media accounts associated with a user;
identify a set of interests based on the user information;
determine a set of suggested life goal elements based on the set of interests;
receive a life goal location from the user, wherein the life goal location indicates a geographic location for achieving the set of suggested life goal elements:
determine a set of compatible life goal elements from the set of suggested life goal elements based on a compatibility determination between characteristics of the life goal location and each respective suggested life goal element of the set of suggested life goal elements for achieving the respective suggested life goal element;
generate a user interface including the set of compatible life goal elements;
receive a selection of one of the compatible life goal elements;
generate display information for the selected life goal element along with: image data associated with a value of the selected life goal element and an adjustment control associated with the selected life goal element that allows modification of the value of the selected life goal element;
receive an adjustment from the adjustment control to modify the value to a new value;
obtain new image data associated with the new value using the hardware processor of the system; and
generate display information for the new image data.

15. The system of claim 14, further comprising instructions to:
implement a transaction consistent with the received adjustment.

16. The system of claim 14, further comprising instructions to:
generate display information for impacted life goal elements along with the selected life goal element;
modify a value of one or more of the impacted life goal elements based on the new value; and
generate display information for the modified value for the impacted life goal elements.

17. The system of claim 16, further comprising instructions to:
receive limitations related to changes allowed for one or more impacted life goal elements, wherein the modifying of the value of the one or more of the impacted life goal elements is within the received limitations.

18. The system of claim 14, further comprising instructions to input the image data via the network interface and from a publicly available source that is external to the computer system.

19. The system of claim 14, further comprising instructions to:
predict, using the processor, a predicted goal element based on the user information; and
add the predicted goal element to the set of suggested life goal elements.

20. A non-transitory computer-readable storage medium, the computer-readable storage medium including instructions that when executed by a computer, cause the computer to perform operations of:
storing, into a memory of a computer system user information from social media accounts associated with a user;
identifying a set of interests based on the user information;
determining a set of suggested life goal elements based on the set of interests;
receiving a life goal location from the user, wherein the life goal location indicates a geographic location for achieving the set of suggested life goal elements determining a set of compatible life goal elements from the set of suggested life goal elements based on a compatibility determination between characteristics of the life goal location and each respective suggested life goal element of the set of suggested life goal elements for achieving the respective suggested life goal element;
generating a user interface including the set of compatible life goal elements;
receiving a selection of one of the compatible life goal elements;
displaying the selected life goal element along with:
a) image data associated with a value of the selected life goal element, and b) an adjustment control associated with the selected life goal element that allows modifying the value of the selected life goal element;
receiving an adjustment from the adjustment control to modify the value to a new value;
obtaining new image data associated with the new value using a processor of the computer system; and
displaying the new image data.
